(19) United States
(12) Patent Application Publication
(10) Pub. No.: US 2013/0198997 A1
(43) Pub. Date: Aug. 8, 2013

(54) CASEMENT WINDOW HINGE

(71) Applicant: AMESBURY GROUP, INC., Amesbury, MA (US)

(72) Inventors: BRAD LOREN OLSON, Sioux Falls, SD (US); CORBY WERON, Centerville, SD (US)

(73) Assignee: AMESBURY GROUP, INC., Amesbury, MA (US)

(21) Appl. No.: 13/760,787

(22) Filed: Feb. 6, 2013

Related U.S. Application Data
(60) Provisional application No. 61/595,978, filed on Feb. 7, 2012.

(51) Int. Cl. E05D 15/30

(52) U.S. Cl. CPC E05D 15/30
USPC 16/364

(57) ABSTRACT

A casement window hinge system includes a track having a base and a return extending from the base. A shoe slidably is engaged with the return and a reinforcing insert or support at least partially surrounds the shoe. A sash arm is pivotably engaged with the insert, while a support arm is pivotably engaged at a first end with the sash arm, and pivotably engaged at a second end with the track.

### CROSS-REFERENCE TO RELATED APPLICATIONS

This application claims priority to and the benefit of U.S. Provisional Patent Application Ser. No. 61/595,978, filed Feb. 7, 2012, entitled “Casement Window Hinge,” the entire disclosure of which is hereby incorporated by reference herein in its entirety.

### INTRODUCTION

The North American Fenestration Standard (NAFS) document dictates how much weight casement window hardware should support (i.e., a hardware load test). This test effectively limits the overall size of casement windows in many cases, because the hinges cannot pass this test on larger units.

An end view of a conventional casement window hinge system 100 is depicted in FIG. 1. The hinge system 100 includes an elongate track 102 having a curved return portion 104. The return portion 104 at least partially surrounds a lip 106 of a hinge shoe 108, such that the lip 106 (and therefore the shoe 108) slides along the track 102. The shoe 108 is prevented from removal from the track 102 due to the interaction between the return 104 and the lip 106. The shoe 108 may be overmolded around a robust insert 110 (such as a metal plate) to provide additional structural integrity to the shoe 108 and the lip 106. A conventional insert thickness may be about 0.04 inches. The overmolding process can be expensive, as it usually requires additional labor or specialized automated equipment to make and integrate the parts. In general, the track 102 is installed in a casement window frame such that the return 104 is located on an interior side of the window. When a force F acts on the shoe 108 due to external loads (e.g., an intruder attempting to pry open the window), a resulting force F_{R} acts against the return portion 104 of the track 102, causing a stress σ on the hinge track 102. This stress σ may be quantified as:

σ=(F_{R})(Y₁)/Iₓ

where Y₁ is the distance above the track 102 upon which F_{R} acts, and Iₓ is centroidal moment of inertia about the x axis. Of course, the greater the distance Y₁, the greater the stress σ, and the higher likelihood of failure.

### SUMMARY

In one aspect, the technology relates to a casement window hinge system having: a track including a base and a return extending from the base; a shoe slidably engaged with the return; an insert at least partially surrounding the shoe; a sash arm pivotably engaged with the insert; and a support arm pivotably engaged at a first end with the sash arm, and pivotably engaged at a second end with the track. In an embodiment, the shoe defines a recess for receiving the return. In another embodiment, the return includes a substantially first portion substantially orthogonal to the track and a second portion substantially parallel to the track. In yet another embodiment, the insert includes a receiver for surrounding an edge of the shoe. In still another embodiment, the receiver surrounds an edge of the return.

In another embodiment of the above aspect, the shoe and the insert each define an opening for receiving a pivot element, wherein the pivot element connects each of the shoe, the insert, and the sash arm. In another embodiment, the return includes a substantially S-shaped profile. In yet another embodiment, the shoe defines a substantially S-shaped recess for receiving the substantially S-shaped return. In still another embodiment, the casement window hinge system includes an adjustment nut pivotably connecting the track and the second end of the support arm. In another embodiment, the insert is integral with the shoe.

In another aspect, the technology relates to a casement window hinge system including: a track including a base and a return extending from a top surface of the base; a shoe defining a recess in a bottom surface of the shoe, wherein the recess is adapted to slidably receive the return; an insert at least partially surrounding the shoe; a sash arm pivotably engaged with the insert; and a support arm pivotably engaged at a first end with the sash arm, and pivotably engaged at a second end with the track. In an embodiment, the insert includes a receiver for surrounding an edge of the shoe. In another embodiment, the receiver surrounds a top surface of the shoe, a first side surface of the shoe, and a portion of the bottom surface of the shoe. In yet another embodiment, the receiver surrounds an edge of the return. In still another embodiment, the system includes an adjustment nut pivotably connecting the track and the second end of the support arm. In another embodiment, the insert is integral with the shoe.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1 is a cross-sectional end view of a conventional casement window hinge system.

FIG. 2 is a cross-sectional end view of a casement window hinge system.

FIGS. 3A and 3B are partial perspective views of a casement window hinge system.

FIGS. 4A and 4B are top views of a casement window hinge system, in closed an open positions, respectively.

FIG. 4C is an exploded perspective view of the casement window hinge system of FIG. 2.

FIG. 5 is a perspective view of an adjustment stud for a casement window hinge system.

FIG. 6 is a partial perspective view of a casement window including the casement window hinge system of FIG. 2, in an open position.

FIG. 7 is a perspective view of a casement window hinge system shoe.

### DETAILED DESCRIPTION

The technology described herein improves maximum window loading capabilities and improves design pressure test results. The reinforced shoe, the specialized track configuration, and other technologies described herein help improve performance, and also reduce manufacturing costs associated with the casement window hinge system. In casement windows, the weakest point of the hardware is the hinge. The designs described herein would allow for larger casement windows while and still meeting loading standards. The design of track is also beneficial for loading because of the decreased lever arm that the loading force is acting upon, which causes a much lower bending stress on the track. This technology utilizes a slide-over insert along with specialized track geometry. Conventional products use a plastic over-molded insert and a track that captures the hinge shoe from the top. There are two weak points with these conventional hinges: the hinge shoe and the track. The design described herein is stronger for a number of reasons.

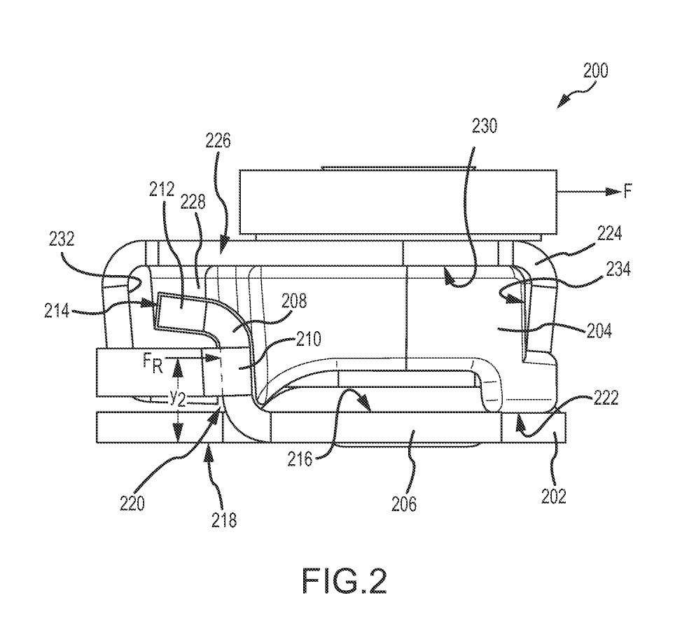

FIG. 2 is a cross-sectional end view of a casement window hinge system 200. The system 200 includes an elongate track 202 and a shoe 204 slidably engaged therewith. The track 202 includes a base portion 206 and a raised return 208. In this embodiment, the return 208 is a substantially S-shaped configuration. The return 208 includes a first portion 210 that is substantially orthogonal to the base 206. The return 208 also includes a second portion 212 that is substantially parallel to the base 202. The second portion 212 of the return 208 terminates at an edge 214. In the depicted embodiment, the return 208 extends upwards from a top surface 216 of the base 206. A bottom surface 218 of the base 206 is generally installed in contact with a casement window.

The shoe 204 defines a recess 220 that in the depicted embodiment is defined by a bottom surface 222 of the shoe 204. The recess 220 is configured and sized to receive the return 208. The shoe 204 is typically an injection-molded piece of plastic, as described in more detail below. A reinforced insert or support 224 substantially surrounds the shoe 204. The insert 224 includes a receiver portion 226 that receives an edge portion 228 of the shoe 204. This edge portion 228 of the shoe 204 also contains the return 208, thus, the receiver 226 also surrounds the return 208. In the depicted embodiment, the insert 224 surrounds a top surface 230 of the shoe 204, both side surfaces 232, 234, and a portion of the bottom surface 222 (proximate the edge portion 228). This configuration increases the strength of the system 200. The insert 224 may be manufactured of metal or other reinforced material, as described further below. In one embodiment, the insert 224 is stainless steel having a thickness of about 0.05 to about 0.06 inches.

Additionally, the S-shaped configuration of the return 208 and recess 220 help reduce or eliminate the likelihood that the shoe 204 may be pulled away from the track 202 as a force F is applied to the window. As depicted above, when a force F acts on the shoe 204 due to external loads (e.g., an intruder attempting to pry open the window), a resulting force F_{R} acts against the return portion 208 of the track 202, causing a stress σ on the hinge track 202. This stress σ may be quantified as:

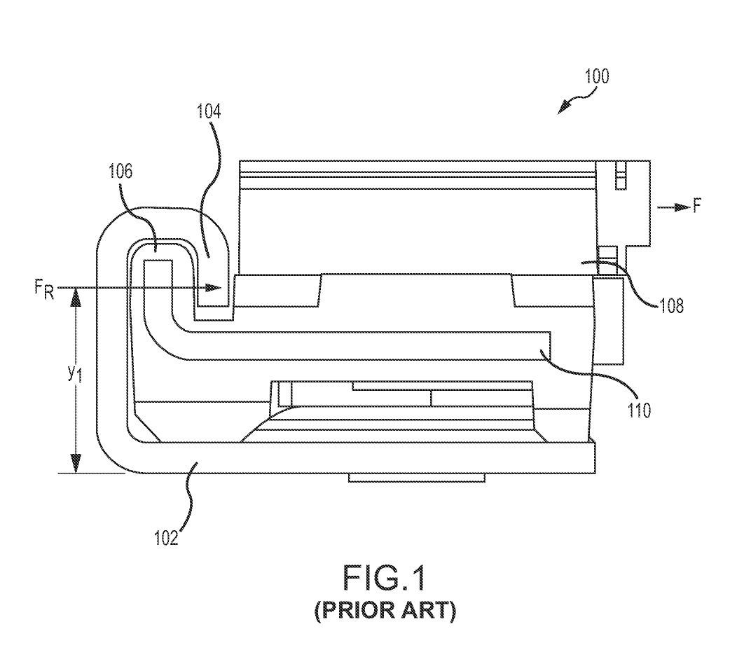

σ=(F_{R})(Y₂)/Iₓ

where Y₂ is the distance above the track 202 upon which F_{R} acts, and Iₓ is centroidal moment of inertia about the x axis. Due to the particular configuration of the return 208, Y₂ is generally less than Y₁ depicted above in FIG. 1. Thus, the stress σ on the track 202 is significantly less than in the prior art configuration. Test results confirming this are described in more detail below.

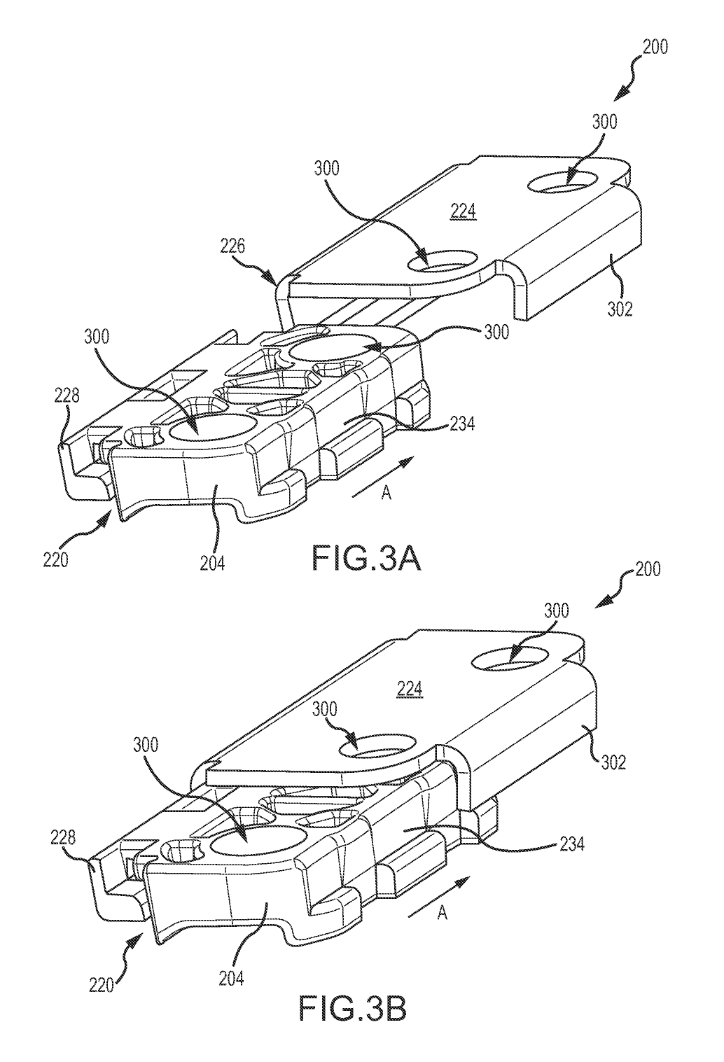

FIGS. 3A and 3B are partial perspective views of a casement window hinge system 200, specifically, the shoe 204 and the insert 224. Each of the shoe 204 and the insert 224 define one or more openings 300 for receiving a pivot element, such as a rivet or pin, which is used to secure the shoe 204 and insert 224 to a sash arm. FIG. 3A depicts the receiver portion 226 of the insert 224 that receives the edge portion 228 of the shoe 204. In the depicted embodiment, the shoe 204 is inserted into the insert 224 in an axial direction A. In an alternative embodiment, the edge 228 of the shoe 204 may be first inserted into the receiver portion 226 of the insert 224. The insert 224 may then be pivoted towards the shoe 204, such that a side portion 302 of the insert 224 clamps around the side surface 234 of the shoe 204.

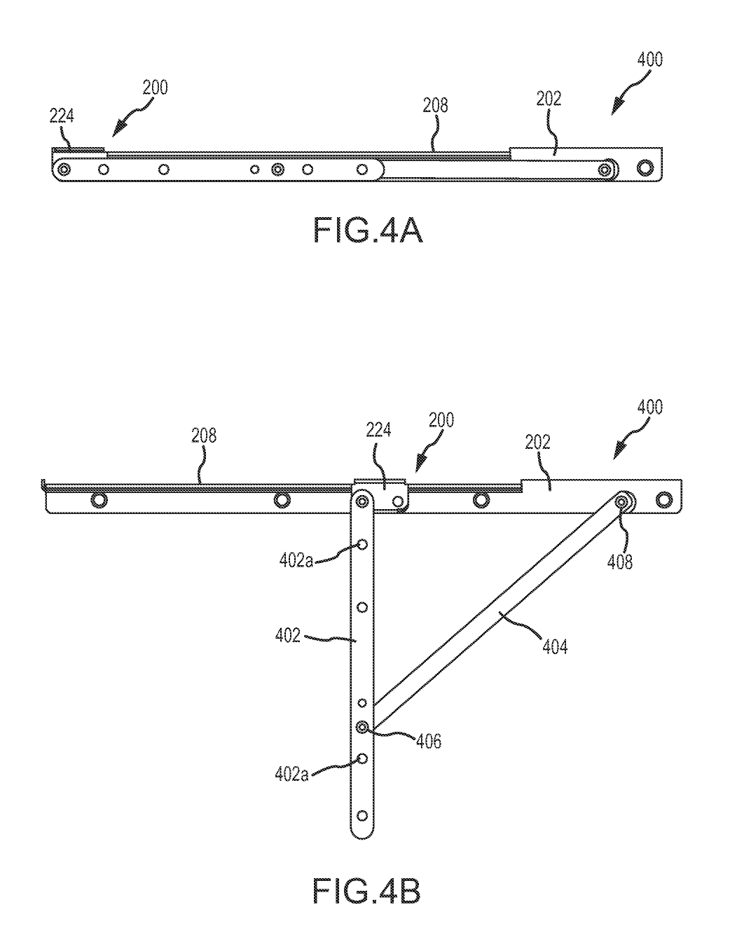

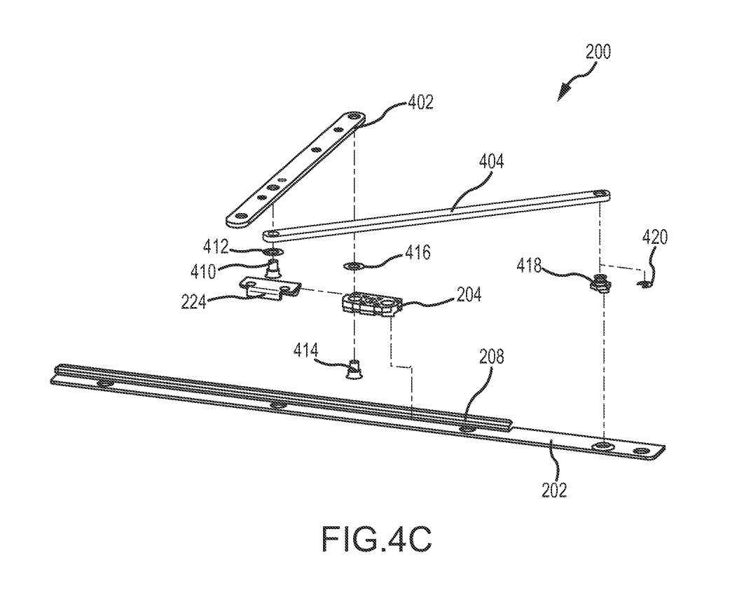

FIGS. 4A and 4B are top views of a casement window hinge system 200, in closed and open positions, respectively. The system 200 includes the shoe, although in the depicted figure, only the insert 224 is visible. The shoe slides along the return 208 of the track 202. A sash arm 402 is pivotably connected to the casement hinge 200. The sash arm 402 defines a number of openings 402a for connection thereof to a window sash. A support arm 404 is pivotably connected at a first end 406 to the sash arm 402, and at the second end 408 to the track 202. Rotation of an actuation element (not shown) pivots the support arm 404 from the closed position of FIG. 4A to the open position of FIG. 4B.

FIG. 4C is an exploded perspective view of the casement window hinge system 200. Specifically, FIG. 4C depicts the pivotable connections between the various elements of the system 200. A pin, rivet, or other pivotable element 410 connects the sash arm 402 to the support arm 404. A washer 412 may be used to reduce friction at the pivot 410. A similar pin, rivet, or other pivotable element 414 is utilized to pivotably connect the shoe 204, insert 224, and sash arm 402. Again, a washer 416 may be used to reduce friction at the pivot 414. An adjustment stud 418 and C-clamp 420 connect the support arm 404 to the track 202.

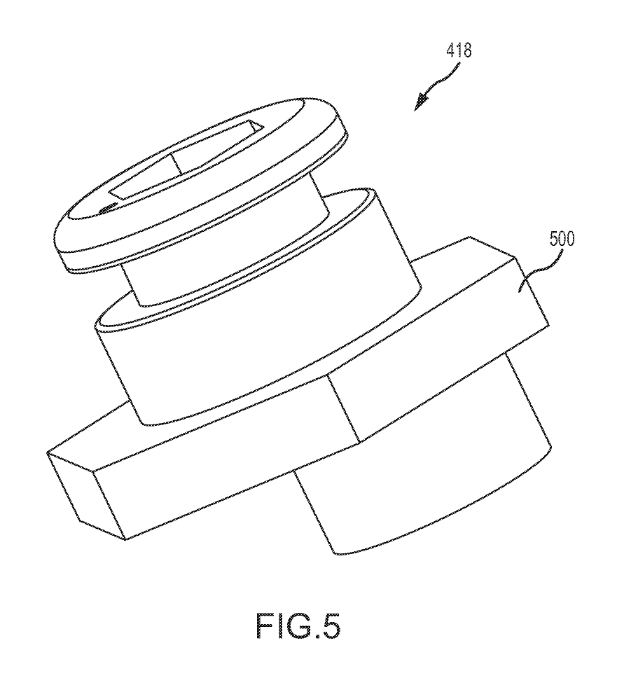

FIG. 5 is a perspective view of the adjustment stud 418. The adjustment stud 418 is a cam, so when it is rotated via a wrench or hex wrench at the interface 500, it allows, in certain embodiments, for 0.078″ of adjustment in both directions in order to adjust the sash of a casement window to account for window sag over time.

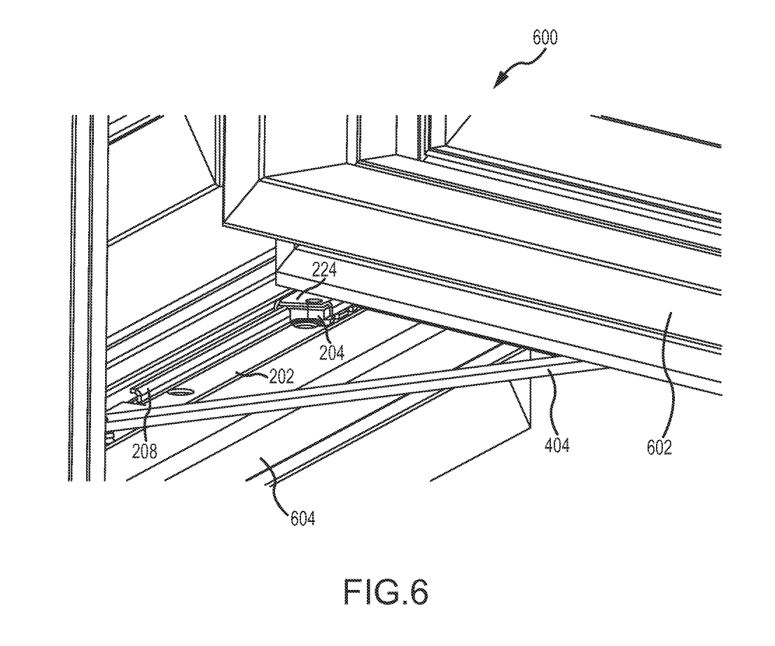

FIG. 6 is a partial perspective view of a casement window 600 including the casement window hinge system 200, in an open position. The casement window 600 includes a pivoting sash 602 installed in a window frame 604. The track 202 is installed on, in this case, a bottom portion of the window frame 604. In other embodiments, a track may be installed additionally or alternatively on an upper portion of a frame 604. The insert 224 and shoe 204 is installed below a corner of the sash 602. The sash arm is installed along the bottom of the sash 602 and is not depicted in this figure. As a crank or actuator (not shown) is rotated, the support arm 404 pivots outward, opening the window 600.

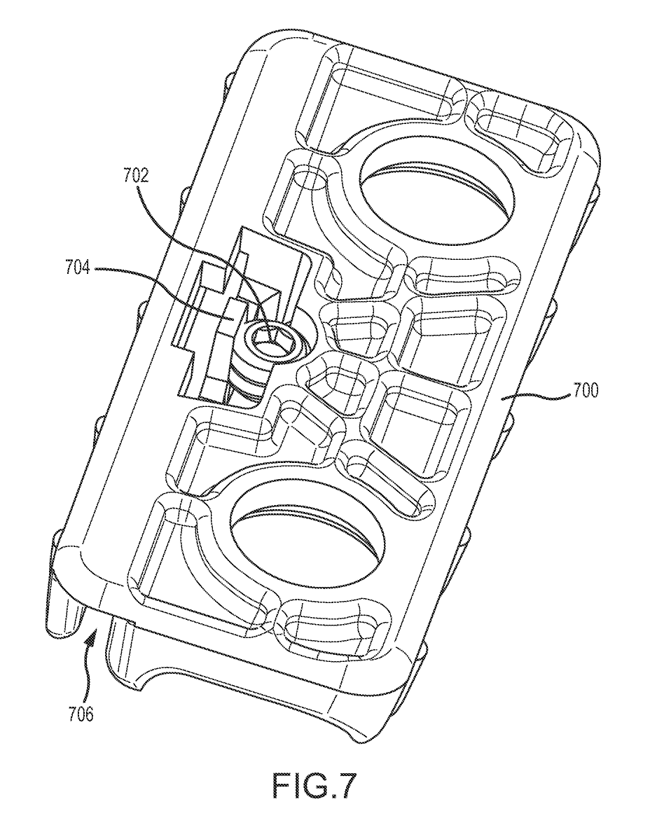

The casement hinge described herein may also be utilized in awning windows, although the adjustment stud (FIG. 5) need not be utilized in that application. FIG. 7 depicts an alternative shoe 700 that may be utilized with casement windows, but that is particularly desirable for use with awning windows. The shoe 700 includes a set screw 702 that increases and decreases the friction against the return (not shown) by moving an internal wall 704 towards and away from the return. As the wall 704 is deflected, friction against the return is adjusted. The return, in this case, would be located in the recess 706.

The depicted casement window hinge system described herein has been tested on casement windows and compared with the performance of conventional casement window hinges, such as the type depicted in FIG. 1. In one test, a hardware load test was performed on a window that utilized conventional casement hinge systems on both the top and bottom of the window. The conventional casement hinge systems performed to a load of about 73 lbs. In comparison, a hardware load test was performed on a window that utilized the disclosed casement hinge systems, on both the top and bottom of the window. The disclosed hinge systems performed to a load of about 172 lbs.

The materials utilized in the manufacture of the casement hinge may be those typically utilized for window hardware manufacture, e.g., zinc, steel, brass, stainless steel, etc. Material selection for most of the components may be based on the proposed use of the hinge, level of security desired, etc. Appropriate materials may be selected for a hinge used on a window that has particular security requirements, as well as on windows subject to certain environmental conditions (e.g., moisture, corrosive atmospheres, etc.). For particularly light-weight windows, molded plastic, such as PVC, polyethylene, etc., may be utilized for the various components. Nylon, acetal, Teflon®, or combinations thereof may be utilized for the hinge to reduce friction, although other low-friction materials are contemplated. The shoe is typically an injection molded plastic component. The insert is typically a more robust material than the shoe, for example, metal, reinforced plastic such as KEVLAR, etc. Although the insert is described as discrete from the shoe, the insert may be integrally formed with the shoe. That is, the shoe may be directly molded only (but not around) the insert. Alternatively, the insert may be adhered to the shoe with a chemical adhesive after manufacturing. A discrete shoe and insert are desirable, however, as such a configuration eliminates the expense and complexity associated with integrating the shoe and reinforcing part as described above in the Introduction.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A casement window hinge system comprising:
a track comprising a base and a return extending from the base;
a shoe slidably engaged with the return;
an insert at least partially surrounding the shoe;
a sash arm pivotably engaged with the insert; and
a support arm pivotably engaged at a first end with the sash arm, and pivotably engaged at a second end with the track.

2. The casement window hinge system of claim 1, wherein the shoe defines a recess for receiving the return.

3. The casement window hinge system of claim 1, wherein the return comprises a substantially first portion substantially orthogonal to the track and a second portion substantially parallel to the track.

4. The casement window hinge system of claim 1, wherein the insert comprises a receiver for surrounding an edge of the shoe.

5. The casement window hinge system of claim 4, wherein the receiver surrounds an edge of the return.

6. The casement window hinge system of claim 1, wherein the shoe and the insert each define an opening for receiving a pivot element, wherein the pivot element connects each of the shoe, the insert, and the sash arm.

7. The casement window hinge system of claim 1, wherein the return comprises a substantially S-shaped profile.

8. The casement window hinge system of claim 7, wherein the shoe defines a substantially S-shaped recess for receiving the substantially S-shaped return.

9. The casement window hinge system of claim 1, further comprising an adjustment nut pivotably connecting the track and the second end of the support arm.

10. The casement window hinge system of claim 1, wherein the insert is integral with the shoe.

11. A casement window hinge system comprising:
a track comprising a base and a return extending from a top surface of the base;
a shoe defining a recess in a bottom surface of the shoe, wherein the recess is adapted to slidably receive the return;
an insert at least partially surrounding the shoe;
a sash arm pivotably engaged with the insert; and
a support arm pivotably engaged at a first end with the sash arm, and pivotably engaged at a second end with the track.

12. The casement window hinge system of claim 11, wherein the insert comprises a receiver for surrounding an edge of the shoe.

13. The casement window hinge system of claim 12, wherein the receiver surrounds a top surface of the shoe, a first side surface of the shoe, and a portion of the bottom surface of the shoe.

14. The casement window hinge system of claim 13, wherein the receiver surrounds an edge of the return.

15. The casement window hinge system of claim 11, further comprising an adjustment nut pivotably connecting the track and the second end of the support arm.

16. The casement window hinge system of claim 11, wherein the insert is integral with the shoe.
